(19) United States
(12) Patent Application Publication
(10) Pub. No.: US 2024/0344558 A1
(43) Pub. Date: Oct. 17, 2024

(54) MAGNETIC BEARING ASSEMBLY, METHOD AND DEVICE FOR CONTROLLING THE SAME, COMPRESSOR AND AIR CONDITIONER

(71) Applicants: GD MIDEA HEATING & VENTILATING EQUIPMENT CO., LTD., Foshan (CN); MIDEA GROUP CO., LTD., Foshan (CN)

(72) Inventors: Bin YANG, Foshan (CN); Shande HU, Foshan (CN); Bao YUE, Foshan (CN); Shuqing LIU, Foshan (CN); Tian LI, Foshan (CN); Weiheng HE, Foshan (CN); Keke JIN, Foshan (CN)

(21) Appl. No.: 18/293,727

(22) PCT Filed: Jan. 3, 2023
(86) PCT No.: PCT/CN2023/070033

§ 371 Date: Jan. 30, 2024

(30) Foreign Application Priority Data
Jan. 6, 2022 (CN) 202210012927.1

(51) Int. Cl. F16C 32/04

(52) U.S. Cl. CPC F16C 32/0444; F16C 32/0474; F16C 2360/00

(57) ABSTRACT

A magnetic bearing assembly includes a rotation shaft having a groove provided at a peripheral surface thereof, and a plurality of distance sensors arranged at a periphery of the rotation shaft and arranged opposite to an annular surface of the rotation shaft where the groove is arranged. The plurality of distance sensors are disposed on a circle, and include N first sensors and N second sensors. N is an integer greater than 1. The first sensors and the second sensors are arranged alternately on the circle. A center of the circle is disposed on an axis of the rotation shaft, and a plane where the circle is disposed is perpendicular to the axis of the rotation shaft.

The present disclosure claims priority to Chinese Patent Application No. 202210012927.1, entitled “magnetic bearing assembly, method and a device for controlling the same, compressor and air conditioner,” filed with CNIPA on Jan. 6, 2022, the entire content of which is incorporated herein by reference.

### TECHNICAL FIELD

The present disclosure relates to the technical field of compressors, and more particularly to a magnetic bearing assembly, a method and a device for controlling the same, a compressor and an air conditioner.

### BACKGROUND

The magnetic levitation compressors are widely used in air conditioning systems due to their low noise, low maintenance costs, high operating efficiency, lightweight body, and low starting current, etc. In related technologies, when detecting a rotation speed of a rotation shaft through a distance measuring probe, the radial fluctuation of the rotation shaft can cause speed signal errors, which reduce the measurement accuracy of the rotation speed of the rotation shaft and affect the normal operation of the compressor.

Therefore, how to design a magnetic bearing assembly that can overcome the aforementioned technical defects has become an urgent technical problem to be solved.

### SUMMARY

The present disclosure is intended to address at least one of the technical problem in the prior art.

For this purpose, a magnetic bearing assembly is proposed in at least one embodiment of the present disclosure.

A method for controlling a magnetic bearing assembly is proposed in at least one embodiment of the present disclosure.

A device for controlling a magnetic bearing assembly is proposed in at least one embodiment of the present disclosure.

A device for controlling a magnetic bearing assembly is proposed in at least one embodiment of the present disclosure.

A readable storage medium is proposed in at least one embodiment of the present disclosure.

A magnetic bearing assembly is proposed in at least one embodiment of the present disclosure.

A compressor is proposed in at least one embodiment of the present disclosure.

An air conditioner is proposed in at least one embodiment of the present disclosure.

In view of this, a magnetic bearing assembly is provided in at least one embodiment of the present disclosure, and the magnetic bearing assembly includes: a rotation shaft and distance sensors, a peripheral surface of the rotation shaft being provided with a groove; and the distance sensors are arranged at a periphery of the rotation shaft and arranged opposite to an annular surface of the rotation shaft where the groove is arranged, and disposed on a first circle; the distance sensors include: N first sensors and N second sensors; the first sensors and the second sensors are arranged alternately on the first circle; the N is an integer greater than 1; and a center of the first circle is disposed on an axis of the rotation shaft, and a plane where the first circle is disposed is perpendicular to the axis of the rotation shaft.

The present disclosure proposes a magnetic bearing assembly, which includes a stator and a rotor arranged around the stator. The rotor rotates under the action of the stator to generate power. On this basis, the magnetic bearing assembly is provided with a rotation shaft, the rotation shaft can be a part of the rotor, or the rotation shaft can be a power output shaft coaxially connected with the rotor, as long as the synchronous rotation of the rotation shaft and the rotor is realized. The periphery of the rotation shaft is provided with a groove, and the magnetic bearing assembly is further provided with the distance sensors, the distance sensors are arranged on the periphery of the rotation shaft, that is, in the area opposite to the peripheral surface of the rotation shaft, and the measuring end of the distance sensor is arranged opposite to the annular surface provided with the groove on the rotation shaft. The distance sensor can measure the distance between itself and the surface of the rotation shaft, after the magnetic bearing assembly is activated, the rotation shaft rotates, and the annular surface provided with the groove then rotates in front of the distance sensors. When the groove faces the probe of the distance sensor, the distance between the distance sensor and the rotation shaft is the first distance. When a position on the peripheral surface of the rotation shaft where the groove is not disposed faces the probe of the distance sensor, the distance between the distance sensor and the rotation shaft is the second distance, the groove is concave relative to the peripheral surface of the rotation shaft, and the first distance is greater than the second distance. Therefore, each time the groove passes through the measurement area of the distance sensor, the distance sensor will generate a pulse signal, that is, the rotation shaft has rotated for one revolution, and then the rotation speed of the rotation shaft can be determined according to the pulse signal.

In related technologies, single or two distance sensors are mostly used to detect the rotation speed of the rotation shaft, but the rotation shaft will inevitably have radial fluctuations in the working process, and the distance sensor also measures the distance between itself and the rotation shaft in the radial direction of the rotation shaft. Therefore, when there is radial fluctuation of the rotation shaft, the distance between the distance sensor and the rotation shaft will change significantly due to the fluctuation, and a pulse signal corresponding to the fluctuation is generated, and the pulse signal will affect the determination of the rotation speed of the rotation shaft, so that the system can obtain a rotation speed value inconsistent with the actual rotation speed. For example, when two distance sensors are symmetrically arranged on two sides of the rotation shaft, if the rotation shaft fluctuates in the direction of one of the distance sensors, the distance measured by the distance sensor will increase abruptly, similar to the distance surge generated when the groove is rotated to the front of the distance sensor, so that the distance sensor will output an error pulse signal before the groove is rotated to the front of the distance sensor. This results in the technical problems such as low measurement accuracy of rotation speed of the rotation shaft, poor control reliability of the rotation shaft, and low rotational stability.

In this regard, the present disclosure makes adjustments to the distance sensors. Specifically, the distance sensors include N first sensors and N second sensors with the same number as the first sensors, and N is an integer greater than 1, that is, at least two pairs of first sensors and second sensors are provided. The first sensors and the second sensors are arranged on a first circle with an axis that is coaxial with the axis of the rotation shaft, and the distances between themselves and the rotation shaft are measured at different positions of the first circle. The N first sensors are combined as a first measurement group, and the N second sensors are combined as a second measurement group. During working, the distance data measured by the N first sensors in the first measurement group is superimposed to obtain the first distance value, and the distance data measured by the N second sensors in the second measurement group is superimposed to obtain the second distance value. Then the difference between the first distance value and the second distance value is used to determine whether the groove is transferred into the measurement area of a distance sensor. Under this measurement structure, when the rotation shaft does not have radial fluctuation, the measured data of each distance sensor are the same, so that the first distance value and the second distance value are equal. When the rotation shaft has radial fluctuation, the distance between the rotation shaft and a sensor increases, and the distance between the sensor and the rotation shaft on the opposite side will correspondingly decrease. The opposite side distance compensation phenomenon can make that the first distance value and the second distance value obtained by summing are similar to ensure that the possible error between the first distance value and the second distance value is much smaller than the depth of the groove, so as to eliminate the influence of the radial fluctuation of the rotation shaft when measures the speed. Correspondingly, when the groove is rotated into the measurement area of a distance sensor, the depth of the groove is increased in the summation distance value of the measurement group, and the summation distance value of the other measurement group cannot make up for this depth, and then the rotation position of the groove can be determined by the sudden increase in the difference between the first distance value and the second distance value, so as to obtain the accurate rotation speed of the rotation shaft. It can be seen that the distance sensor array defined in the present disclosure can solve the problem of eliminating the influence of the radial fluctuation when measures the rotation speed of the rotation shaft, and then solve the technical problems of the output error pulse signal, low speed measurement accuracy and poor working reliability of the rotation shaft in related technologies.

On this basis, on the first circle where the distance sensors are distributed, the first sensors and the second sensors are arranged alternately. This layout can improve the distribution uniformity of the first sensors and the second sensors, avoid the absence of the first sensors or the second sensors in a certain area, and ensure that the opposite side distance compensation phenomenon can be applied to the first distance value and second distance value measured by the first measurement group and the second measurement group, so as to improve the measurement reliability. Thus, the technical effects of optimizing the structure of the magnetic bearing assembly, improving the measurement accuracy of the rotation speed of the rotor, improving the control accuracy of the magnetic bearing assembly, and reducing the failure rate of the magnetic bearing assembly are realized.

In addition, the magnetic bearing assembly provided herein can have the following additional technical features:

In the above technical solution, the distance sensors are uniformly distributed on the first circle.

In this technical solution, the distribution mode of the distance sensors is explained. Specifically, a plurality of distance sensors are evenly distributed on the first circle, that is, the first sensors and the second sensors alternately arranged on the first circle are arranged spaced apart from each other. Uniformly distributing the distance sensors on the basis of alternating arranging can reduce the difference between the first distance value and second distance value when radial fluctuations occur in the rotation shaft, so as to further reduce the influence of radial fluctuations on the measurement accuracy of the rotation speed of the rotation shaft, and ensure that the distance sensor will not output error pulse signals. Thus the technical effects of optimizing the layout of the distance sensors, improving the measurement accuracy and reliability of the rotation speed of the rotation shaft, and reducing the failure rate of the magnetic bearing assembly are realized.

In any one of the above technical solutions, the distance sensors include: a third sensor and a fourth sensor; the central angle between the third sensor and the fourth sensor on the first circle is 180°; the N first sensors include the third sensor and the fourth sensor.

In the technical solution, a special implementation solution is proposed. In the solution, the first sensor group consists of two sensors including the third sensor and the fourth sensor. In addition, the central angle between the third sensor and the fourth sensor on the first circle is 180°, that is, the third sensor and the fourth sensor are arranged on a same diameter. The number of the first sensors and the second sensors is the same. By limiting the first sensors and the second sensors that are including two sensors, the procurement cost of the sensor can be reduced on the basis of meeting the measurement accuracy of the rotation speed. By distributing the third sensor and the fourth sensor on the same diameter, on the one hand, the compensation effect between the third sensor and the fourth sensor can be improved, and on the other hand, the two second sensors can be distributed on the left and right sides of the diameter where the third sensor and the fourth sensor are disposed to further improve the distance compensation effect and improve the accuracy of determining the orientation of groove on the rotation shaft. Thus the technical effects of optimizing the layout of the distance sensors, improving the measurement accuracy and reliability of the rotation speed of the rotation shaft, and reducing the failure rate of the magnetic bearing assembly are realized.

In any one of the above technical solutions, the distance sensors include: a fifth sensor and a sixth sensor, the central angle between the fifth sensor and the third sensor on the first circle is 90°, the central angle between the fifth sensor and the sixth sensor is greater than or equal to 135°, and less than or equal to 225°; the N second sensors include the fifth sensor and the sixth sensor.

In the technical solution, following the above technical solution, the distribution mode of the two second sensors is defined. Specifically, the second sensor group consists of the fifth sensor and the sixth sensor. On the first circle where the distance sensors are disposed, the central angles between the fifth sensor and the third sensor as well as the fourth sensor are 90°, that is, the fifth sensor is arranged on a diameter perpendicular to the diameter where the third sensor and the fourth sensor are disposed. On this basis, the sixth sensor is arranged on an opposite side relative to the fifth sensor, and the central angle between the sixth sensor and the fifth sensor on the first circle should be greater than or equal to 135° and less than or equal to 225°. By limiting the distance between the fifth sensor and the sixth sensor, the opposite side distance compensation effect can be ensured, which avoids the error pulse signal generated when radial fluctuations occur in the rotation shaft due to distribution mode of exceeding the angle range, so as to improve the measurement accuracy of the rotation speed of the rotation shaft. The central angle between the fifth sensor and the sixth sensor can be adjusted adaptively according to the actual working condition of the rotation shaft. For example, when determines that the fluctuation frequency of the rotation shaft in a certain direction is higher according to the working data, the central angle between the fifth sensor and the sixth sensor can be adjusted to make the fifth sensor or the sixth sensor corresponding to the high-frequency fluctuation direction, so as to further enhance the measurement accuracy of the rotation speed of the rotation shaft. Optionally, a sixth sensor with a central angle of 180° from the fifth sensor can be configured to make this distance sensor array suitable for most applications. Thus the technical effects of optimizing the layout of the distance sensors, improving the measurement accuracy and reliability of the rotation speed of the rotation shaft, and reducing the failure rate of the magnetic bearing assembly are realized.

In any one of the above technical solutions, the magnetic bearing assembly further includes: a locating member arranged on the periphery of the rotation shaft; first position holes arranged on the locating member, and the first sensors are embedded in the first position holes; and second locating holes arranged on the locating member, and the second sensors are embedded in the second locating holes.

In the technical solution, the magnetic bearing assembly further includes the locating member, and the locating member is arranged on the periphery of the rotation shaft and is spaced apart from the rotation shaft; the locating member is used to position and mount the first sensors and the second sensors. Specifically, the locating member is provided with first locating holes and second locating holes. The first locating holes are used to position and mount the first sensors, and the second locating holes are used to position and mount the second sensors. By arranging the locating member, the first sensors and the second sensors can be accurately positioned on the predetermined mounting positions on the periphery of the rotation shaft to improve the assembly accuracy and working stability. The arrangement of the locating member can reduce the assembly difficulty of the first sensors and the second sensors. The locating member is a metal part, for example, the locating member can be prepared by aluminum. The first sensors and the second sensors are embedded inside the first through holes and the second through holes respectively. By providing the metal locating member and embedding the second sensors and the first sensors inside the metal locating member, the electric field generated by the moving sensors and the first sensors can be prevented from extending to the non-measurement direction on the basis of meeting the measurement demand through the opening of the positioning hole. Thus, the interference of the moving sensors and the first sensors to the magnetic field generated by the stator can be reduced. Thus, the rotation stability of the rotor is improved and the probability of eccentric rotation is reduced. Thus the technical effects of optimizing the structure of the magnetic bearing assembly, improving the positioning accuracy and working stability of the sensor, improving the measurement accuracy of the rotation speed of the rotation shaft, and improving the working reliability of the magnetic bearing assembly are realized.

In any one of the above technical solutions, the locating member is annular, and the locating member is coaxial with the rotation shaft.

In the technical solution, the shape and position of the locating member are defined. Specifically, the locating member is an annular locating member, which can be selected as an aluminum ring. On this basis, the locating member is sleeved on the periphery of the rotation shaft, and is spaced apart from the rotation shaft, and the axis of the annular locating member coincides with the axis of the rotation shaft. By arranging a coaxial annular locating member, the difference value between the distances between any two of the first sensors and the axis of the rotation shaft can be reduced, and the difference value between the distances between any two of the second sensors and the axis of the rotation shaft can also be reduced, so as to avoid the distance difference caused by the positioning affecting the measuring accuracy of the rotation speed and the displacement of the rotation shaft. Thus the technical effects of optimizing the position structure of the magnetic bearing assembly, improving the positioning accuracy and working stability of the sensor, improving the measurement reliability and accuracy of the rotation speed of the rotation shaft, and the working reliability of the magnetic bearing assembly are realized.

In any one of the above technical solutions, the first position holes and the second locating holes extend in the radial direction of the locating member.

In the technical solution, the first position holes and the second position holes on the locating member extend in the radial direction of the locating member. Since the annular locating member and the rotation shaft are coaxial, the first locating holes and the second locating holes also extend in the radial direction of the rotation shaft, where the openings of the first locating holes and the second locating holes are towards the rotation shaft. The arrangement that the first position holes and the second locating holes extend in the radial direction makes the measuring ends of the first sensors and the second sensors to be aligned with the peripheral surface of the rotation shaft in the radial direction. The positioning deviation affecting the measurement accuracy of the first sensors and the second sensors is avoided, and the reliability of the measured data is improved. Thus the technical effects of optimizing the position structure of the distance sensor, improving the positioning accuracy and working stability of the rotation shaft, and improving the working reliability of the magnetic bearing assembly are realized.

In any one of the above technical solutions, the magnetic bearing assembly further includes an electrical control member, arranged on the locating member and connected with the first sensors and the second sensors.

In the technical solution, the magnetic bearing assembly is further provided with the electrical control member. Specifically, the locating member is provided with a positioning slot, and the electrical control member is inserted into the positioning slot to position and support the electrical control member through the locating member. One of the end surfaces of the annular locating member is provided with an annular groove, the annular groove communicates the first position hole, the second positioning hole and the positioning slot, and the first sensors and the second sensors are then embedded in the first locating holes and the second locating holes, part of the first sensors and the second sensors are disposed in the annular groove. By arranging the annular groove, which can provide layout space for the connection lines between the electric control member and the sensors, avoid the connection lines from extending to the outside of the locating member, and prevent the connection lines from interfering with the rotation of the rotation shaft. On this basis, the magnetic bearing assembly is further provided with an annular cover body, the cover body can be covered on the annular groove, on the one hand to prevent the electric field generated by the sensors from extending outward, on the other hand to avoid the connection lines from extending to the outside of the annular groove. Thus the technical effects of optimizing the structure of the locating member, improving the working safety and reliability of the magnetic bearing assembly, and reducing the failure rate of magnetic bearing assembly are realized.

A control for controlling a magnetic bearing assembly is provided in at least one embodiment of the present disclosure, and the method configured for controlling the magnetic bearing assembly in any one of the above technical solutions, and the method includes:
obtaining first distance information between the first sensors and the rotation shaft and second distance information between the second sensors and the rotation shaft;
determining position information of the groove according to the first distance information and the second distance information; and
determining a rotation speed of the rotation shaft according to the position information.

In the technical solution, a method control for controlling the magnetic bearing assembly in any of above technical solutions. The magnetic bearing assembly includes a stator and a rotor arranged around the stator. The rotor rotates under the action of the stator to generate power. On this basis, the magnetic bearing assembly is provided with a rotation shaft, the rotation shaft can be a part of the rotor, or the rotation shaft can be a power output shaft coaxial connected with the rotor, as long as the synchronous rotation of the rotation shaft and the rotor is realized. The periphery of the rotation shaft is provided with a groove, and the magnetic bearing assembly is further provided with distance sensors, the distance sensors are arranged on the periphery of the rotation shaft, that is, in the area opposite to the peripheral surface of the rotation shaft, and the measuring end of the distance sensor is arranged opposite to the annular surface provided with the groove on the rotation shaft. The distance sensor can measure the distance between itself and the surface of the rotation shaft, after the magnetic bearing assembly is activated, the rotation shaft rotates, and the annular surface provided with the groove then rotates in front of the distance sensors. When the groove faces the probe of the distance sensor, the distance between the distance sensor and the rotation shaft is the first distance. When a position on the peripheral surface of the rotation shaft where the groove is not disposed faces the probe of the distance sensor, the distance between the distance sensor and the rotation shaft is the second distance, the groove is concave relative to the peripheral surface of the rotation shaft, and the first distance is greater than the second distance. Therefore, each time the groove passes through the measurement area of the distance sensor, the distance sensor will generate a pulse signal, that is, the rotation shaft has rotated for one revolution, and then the rotation speed of the rotation shaft can be determined according to the pulse signal.

Specifically, the distance sensors include N first sensors and N second sensors with the same number as the first sensors, and N is an integer greater than 1, that is, at least two pairs of first sensors and second sensors are provided. The first sensors and the second sensors are arranged on a first circle with an axis that is coaxial with the axis of the rotation shaft, and the distances between themselves and the rotation shaft are measured at different positions of the first circle. The N first sensors are combined as a first measurement group, and the N second sensors are combined as a second measurement group.

The specific steps to control the working of the magnetic bearing assembly are as follows: in a first step, the first distance information between the first sensors and the rotation shaft is obtained at the first sensors, and the second distance information between the second sensors and the rotation shaft is obtained at the second sensors. The distance data measured by N first sensors in the first measurement group are superimposed to obtain the first distance information, and the distance data measured by N second sensors in the second measurement group are superimposed to obtain the second distance information. In a second step, the rotation position information of the groove is determined according to the first distance information and the second distance information. Then the difference between the first distance value and the second distance value is used to determine whether the groove is transferred into the measurement area of a distance sensor. Under this measurement structure, when the rotation shaft does not have radial fluctuation, the measured data of each distance sensor are the same, so that the first distance value and the second distance value are equal. When the rotation shaft has radial fluctuation, the distance between the rotation shaft and a sensor increases, and the distance between the sensor and the rotation shaft on the opposite side will correspondingly decrease. The opposite side distance compensation phenomenon can make that the first distance value and the second distance value obtained by summing are similar to ensure that the possible error between the first distance value and the second distance value is much smaller than the depth of the groove, so as to eliminate the influence of the radial fluctuation of the rotation shaft when measures the speed. Correspondingly, when the groove is rotated into the measurement area of a distance sensor, the depth of the groove is increased in the summation distance value of the measurement group, and the summation distance value of the other measurement group cannot make up for this depth, and then the rotation position of the groove can be determined by the sudden increase in the difference between the first distance value and the second distance value. In a third step, the rotation speed of the rotation shaft can be determined according to the identified position information of the groove. The current rotation speed of the rotation shaft can be determined according to the interval time between the two distance sensors and the preset angle difference between the two distance sensors, and the rotation speed will not be affected by the radial fluctuation of the rotation shaft, and the accuracy and reliability are high, thereby improving the reliability of the measurement. Thus, the technical effects of optimizing the structure of the magnetic bearing assembly, improving the measurement accuracy of the rotation speed of the rotor, improving the control accuracy of the magnetic bearing assembly, and reducing the failure rate of the magnetic bearing assembly are realized.

A device for controlling a magnetic bearing assembly is provided in at least one embodiment of the present disclosure, and the device includes: an obtaining unit, configured for obtaining first distance information between first sensors and a rotation shaft and second distance information between second sensors and the rotation shaft; a first determination unit, configured for determining position information of a groove according to the first distance information and the second distance information; and a second determination unit, configured for determining a rotation speed of the rotation shaft according to the position information.

In the technical solution, a device for controlling the operation of the magnetic bearing assembly in any of the technical solutions is defined. The magnetic bearing assembly includes a stator and a rotor arranged around the stator. The rotor rotates under the action of the stator to generate power. On this basis, the magnetic bearing assembly is provided with a rotation shaft, the rotation shaft can be a part of the rotor, or the rotation shaft can be a power output shaft coaxial connected with the rotor, as long as the synchronous rotation of the rotation shaft and the rotor is realized. The periphery of the rotation shaft is provided with a groove, and the magnetic bearing assembly is further provided with distance sensors, the distance sensors are arranged on the periphery of the rotation shaft, that is, in the area opposite to the peripheral surface of the rotation shaft, and the measuring end of the distance sensor is arranged opposite to the annular surface provided with the groove on the rotation shaft. The distance sensor can measure the distance between itself and the surface of the rotation shaft, after the magnetic bearing assembly is activated, the rotation shaft rotates, and the annular surface provided with the groove then rotates in front of the distance sensors. When the groove faces the probe of the distance sensor, the distance between the distance sensor and the rotation shaft is the first distance. When a position on the peripheral surface of the rotation shaft where the groove is not disposed faces the probe of the distance sensor, the distance between the distance sensor and the rotation shaft is the second distance, the groove is concave relative to the peripheral surface of the rotation shaft, and the first distance is greater than the second distance. Therefore, each time the groove passes through the measurement area of the distance sensor, the distance sensor will generate a pulse signal, that is, the rotation shaft has rotated for one revolution, and then the rotation speed of the rotation shaft can be determined according to the pulse signal.

Specifically, the distance sensors include N first sensors and N second sensors with the same number as the first sensors, and N is an integer greater than 1, that is, at least two pairs of first sensors and second sensors are provided. The first sensors and the second sensors are arranged on a first circle with an axis that is coaxial with the axis of the rotation shaft, and the distances between themselves and the rotation shaft are measured at different positions of the first circle. The N first sensors are combined as a first measurement group, and the N second sensors are combined as a second measurement group.

The device for controlling the magnetic bearing assembly includes the obtaining unit, the first determination unit, and the second determination unit; the obtaining unit can obtain the first distance information between the first sensors and the rotation shaft at the first sensors, as well as the second distance information between the second sensors and the rotation shaft at the second sensors. The distance data measured by N first sensors in the first measurement group are superimposed to obtain the first distance information, and the distance data measured by N second sensors in the second measurement group are superimposed to obtain the second distance information. The first determination unit determines the rotation position information of the groove according to the first distance information and the second distance information. Then the difference between the first distance value and the second distance value is used to determine whether the groove is transferred into the measurement area of a distance sensor. Under this measurement structure, when the rotation shaft does not have radial fluctuation, the measured data of each distance sensor are the same, so that the first distance value and the second distance value are equal. When the rotation shaft has radial fluctuation, the distance between the rotation shaft and a sensor increases, and the distance between the sensor and the rotation shaft on the opposite side will correspondingly decrease. The opposite side distance compensation phenomenon can make that the first distance value and the second distance value obtained by summing are similar to ensure that the possible error between the first distance value and the second distance value is much smaller than the depth of the groove, so as to eliminate the influence of the radial fluctuation of the rotation shaft when measures the speed. Correspondingly, when the groove is rotated into the measurement area of a distance sensor, the depth of the groove is increased in the summation distance value of the measurement group, and the summation distance value of the other measurement group cannot make up for this depth, and then the rotation position of the groove can be determined by the sudden increase in the difference between the first distance value and the second distance value. The second determination unit determines the rotation speed of the rotation shaft according to the identified position information of the groove. The current rotation speed of the rotation shaft can be determined according to the interval time between the two distance sensors and the preset angle difference between the two distance sensors, and the rotation speed will not be affected by the radial fluctuation of the rotation shaft, and the accuracy and reliability are high, thereby improving the reliability of the measurement. Thus, the technical effects of optimizing the structure of the magnetic bearing assembly, improving the measurement accuracy of the rotation speed of the rotor, improving the control accuracy of the magnetic bearing assembly, and reducing the failure rate of the magnetic bearing assembly are realized.

A device for controlling a magnetic bearing assembly is provided in at least one embodiment of the present disclosure, which includes: a memory on which a program or instruction is stored; a processor configured for implementing steps of the method for controlling the magnetic bearing assembly in above technical solution when executing the programs or instructions.

In the technical solution, the device for controlling the magnetic bearing assembly is proposed, which includes a memory for storing instructions or programs, and a processor for calling and executing the instructions or programs stored in the memory to implement the steps of the method for controlling the magnetic bearing component in any one of the above technical solutions. Therefore, the control device has the advantages of the method for controlling the magnetic bearing component in any one of the above technical solutions, and can achieve the technical effects that can be achieved by the method for controlling the magnetic bearing assembly in the above technical solutions. In order to avoid repetition, which is not detailed here.

At least one embodiment of the present disclosure provides a readable storage medium on which programs or instructions are stored, and when the programs or instructions are executed by a processor to implement steps of the method for controlling the magnetic bearing assembly in the above technical solution.

In the technical solution, the readable storage medium is proposed on which instructions or programs can be called and executed by the processor. When the processor executes the instructions or programs, the steps of the method for controlling the magnetic bearing component in any one of the above technical solutions can be realized. Therefore, the readable storage medium has the advantages of the method for controlling the magnetic bearing assembly in any one of the above technical solutions, and can achieve the technical effects that can be achieved by the method for controlling the magnetic bearing assembly in the above technical solutions. In order to avoid repetition, which is not detailed here.

A magnetic bearing assembly is provided in at least one embodiment of the present disclosure. The magnetic bearing assembly includes: the device for controlling the magnetic bearing assembly in above technical solution; and/or the readable storage medium in above technical solution. In order to avoid repetition, which is not detailed here.

In the technical solution, the magnetic bearing assembly including the device for controlling the magnetic bearing assembly in above technical solution and/or the readable storage medium in above technical solution is proposed. Therefore, the magnetic bearing assembly has the advantages of the device for controlling the magnetic bearing assembly and/or the readable storage medium in any one of above technical solutions, and can achieve the technical effects that can be achieved by the device for controlling the magnetic bearing assembly and/or the readable storage medium in above technical solutions.

A compressor is provided in at least one embodiment of the present disclosure, including a magnetic bearing assembly in any one of above technical solutions.

In the technical solution, a compressor including a magnetic bearing assembly in any one of above technical solutions is proposed. Therefore, the compressor has the advantages of the magnetic bearing assembly in any one of the above technical solutions, and can achieve the technical effects that can be achieved by the magnetic bearing assembly in any one above technical solutions. In order to avoid repetition, which is not detailed here.

An air conditioner is provided in at least one embodiment of the present disclosure, which includes the compressor in any one above technical solutions.

In the technical solution, an air conditioner including a compressor in the technical solution is proposed. Therefore, the air conditioner has the advantages of the compressor in the above technical solution, and can achieve the technical effect that the compressor in the above technical solution can achieve. In order to avoid repetition, which is not detailed here.

Additional aspects and advantages of the present disclosure will become apparent in the description section below or become known through the practice of the present disclosure.

### BRIEF DESCRIPTION OF THE DRAWINGS

The above and/or additional aspects and advantages of the present disclosure will become apparent and easily understood from the description of embodiments in conjunction with the drawings below, where:

FIG. 1 is a first structural schematic view of a magnetic bearing assembly according to some embodiments of the present disclosure;

FIG. 2 is a second structural schematic view of a magnetic bearing assembly according to some embodiments of the present disclosure;

FIG. 3 is an output waveform diagram of a distance sensor according to some embodiments of the present disclosure;

FIG. 4 is a flowchart of a method for controlling a magnetic bearing assembly according to some embodiments of the present disclosure;

FIG. 5 is a first structural block diagrams of a device for controlling a magnetic bearing assembly according to some embodiments of the present disclosure; and

FIG. 6 is a second structural block diagrams of a device for controlling a magnetic bearing assembly according to some embodiments of the present disclosure.

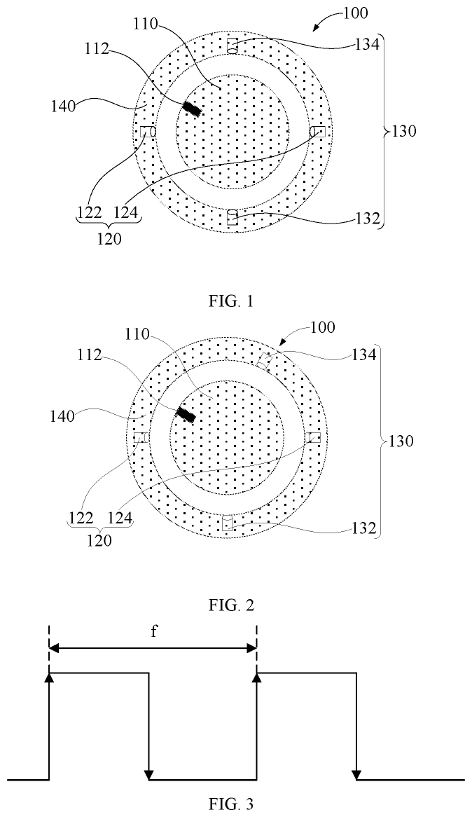

The corresponding relationship between the reference numerals and the technical features in FIGS. 1 and 2 are as following:

100—magnetic bearing assembly, 110—rotation shaft, 112—groove, 120—first sensor, 122—third sensor, 124—fourth sensor, 130—second sensor, 132—fifth sensor, 134—sixth sensor, 140—locating member.

### DETAILED DESCRIPTION OF EMBODIMENTS

In order to better understand the above purposes, features and advantages of the present disclosure, the present disclosure is further described in detail in conjunction with the attached drawings and specific embodiments. It should be noted that the embodiments of the present disclosure and the features in the embodiments may be combined with each other without conflict.

Many specific details are set forth in the description below to facilitate a full understanding of the present disclosure; however, the present disclosure may be implemented in ways other than those described herein, and therefore the scope of protection of the present disclosure is not limited by the specific embodiments disclosed below.

The magnetic bearing assembly, the method and the device for controlling the same, the compressor and the air conditioner according to some embodiments of the present disclosure are described below with reference to FIGS. 1 to 6.

As shown in FIGS. 1, 2 and 3, the magnetic bearing assembly 100 is provided in at least one embodiment of the present disclosure, and the magnetic bearing assembly 100 includes: a rotation shaft 110, a peripheral surface of the rotation shaft 100 is provided with a groove 112; and distance sensors, arranged at a periphery of the rotation shaft 110 and arranged opposite to an annular surface of the rotation shaft 110 where the groove 112 is arranged, and disposed on a first circle; the distance sensors include: N first sensors 120 and N second sensors 130; the first sensors 120 and the second sensors 130 are arranged alternately on the first circle; the N is an integer greater than 1; and a center of the first circle is disposed on an axis of the rotation shaft 110, and a plane where the first circle is disposed is perpendicular to the axis of the rotation shaft 110.

The present disclosure proposes a magnetic bearing assembly 100, which includes a stator and a rotor arranged around the stator. The rotor rotates under the action of the stator to generate power. On this basis, the magnetic bearing assembly 100 is provided with a rotation shaft 110, the rotation shaft 110 can be a part of the rotor, or the rotation shaft 110 can be a power output shaft coaxial connected with the rotor, as long as the synchronous rotation of the rotation shaft 110 and the rotor is realized. The periphery of the rotation shaft 110 is provided with a groove 112, and the magnetic bearing assembly 100 is further provided with distance sensors, the distance sensors are arranged on the periphery of the rotation shaft 110, that is, in the area opposite to the peripheral surface of the rotation shaft 110, and the measuring end of the distance sensor is arranged opposite to the annular surface provided with the groove 112 on the rotation shaft 110. The distance sensor can measure the distance between itself and the surface of the rotation shaft 110, after the magnetic bearing assembly 100 is activated, the rotation shaft 110 rotates, and the annular surface provided with the groove 112 then rotates in front of the distance sensors. When the groove 112 faces the probe of the distance sensor, the distance between the distance sensor and the rotation shaft 110 is the first distance. When a position on the peripheral surface of the rotation shaft 110 where the groove 112 not disposed faces the probe of the distance sensor, the distance between the distance sensor and the rotation shaft 110 is the second distance, the groove 112 is concave relative to the peripheral surface of the rotation shaft 110, and the first distance is greater than the second distance. Therefore, each time the groove 112 passes through the measurement area of the distance sensor, the distance sensor will generate a pulse signal, that is, the rotation shaft 110 has rotated for one revolution, and then the rotation speed of the rotation shaft 110 can be determined according to the pulse signal.

In related technologies, single or two distance sensors are mostly used to detect the rotation speed of the rotation shaft 110, but the rotation shaft 110 will inevitably have radial fluctuations in the working process, and the distance sensor also measures the distance between itself and the rotation shaft 110 in the radial direction of the rotation shaft 110. Therefore, when there is radial fluctuation of the rotation shaft 110, the distance between the distance sensor and the rotation shaft 110 will change significantly due to the fluctuation, and a pulse signal corresponding to the fluctuation is generated, and the pulse signal will affect the determination of the rotation speed of the rotation shaft 110, so that the system can obtain a rotation speed value inconsistent with the actual rotation speed. For example, when two distance sensors are symmetrically arranged on two sides of the rotation shaft 110, if the rotation shaft 110 fluctuates in the direction of one of the distance sensors, the distance measured by the distance sensor will increase abruptly, similar to the distance surge generated when the groove is rotated to the front of the distance sensor, so that the distance sensor will output an error pulse signal before the groove 112 is rotated to the front of the distance sensor. This results in the technical problems such as low measurement accuracy of rotation speed of the rotation shaft 110, poor control reliability of the rotation shaft 110, and low rotational stability.

In this regard, the present disclosure makes adjustments to the distance sensors. Specifically, the distance sensors include N first sensors 120 and N second sensors 130 with the same number as the first sensors 120, and N is an integer greater than 1, that is, at least two pairs of first sensors 120 and second sensors 130 are provided. The first sensors 120 and the second sensors 130 are arranged on a first circle with an axis that is coaxial with the axis of the rotation shaft 110, and the distances between themselves and the rotation shaft 110 are measured at different positions of the first circle. The N first sensors 120 are combined as a first measurement group, and the N second sensors 130 are combined as a second measurement group. During working, the distance data measured by the N first sensors 120 in the first measurement group is superimposed to obtain the first distance value, and the distance data measured by the N second sensors 130 in the second measurement group is superimposed to obtain the second distance value. Then the difference between the first distance value and the second distance value is used to determine whether the groove 112 is transferred into the measurement area of a distance sensor. Under this measurement structure, when the rotation shaft 110 does not have radial fluctuation, the measured data of each distance sensor are the same, so that the first distance value and the second distance value are equal. When the rotation shaft 110 has radial fluctuation, the distance between the rotation shaft 110 and a sensor increases, and the distance between the sensor and the rotation shaft 110 on the opposite side will correspondingly decrease. The opposite side distance compensation phenomenon can make that the first distance value and the second distance value obtained by summing are similar to ensure that the possible error between the first distance value and the second distance value is much smaller than the depth of the groove 112, so as to eliminate the influence of the radial fluctuation of the rotation shaft 110 when measures the speed. Correspondingly, when the groove 112 is rotated into the measurement area of a distance sensor, the depth of the groove 112 is increased in the summation distance value of the measurement group, and the summation distance value of the other measurement group cannot make up for this depth, and then the rotation position of the groove 112 can be determined by the sudden increase in the difference between the first distance value and the second distance value, so as to obtain the accurate rotation speed of the rotation shaft 110. For example, in the waveform diagram shown in FIG. 3, the peak represents the groove 112 turning into the measurement area of a certain distance sensor, and the trough represents the groove 112 turning out of the measurement area of the distance sensor. It can be seen that the distance sensor array defined in the disclosure can solve the problem of eliminating the influence of the radial fluctuation when measures the rotation speed of the rotation shaft 110, and then solve the technical problems of the output error pulse signal, low speed measurement accuracy and poor working reliability of the rotation shaft 110 in related technologies.

On this basis, on the first circle where the distance sensors are distributed, the first sensors 120 and the second sensors 130 are arranged alternately. This layout can improve the distribution uniformity of the first sensors 120 and the second sensors 130, avoid the absence of the first sensors 120 or the second sensors 130 in a certain area, and ensure that the opposite side distance compensation phenomenon can be applied to the first distance value and second distance value measured by the first measurement group and the second measurement group, so as to improve the measurement reliability. Thus, the technical effects of optimizing the structure of the magnetic bearing assembly 100, improving the measurement accuracy of the rotation speed of the rotor, improving the control accuracy of the magnetic bearing assembly 100, and reducing the failure rate of the magnetic bearing assembly 100 are realized.

In the above embodiment, the distance sensors are uniformly distributed on the first circle.

In this embodiment, the distribution mode of the distance sensors is explained. Specifically, a plurality of distance sensors are evenly distributed on the first circle, that is, the first sensors 120 and the second sensors 130 alternately arranged on the first circle are arranged spaced apart from each other. Uniformly distributing the distance sensors on the basis of alternating arranging can reduce the difference between the first distance value and second distance value when radial fluctuations occur in the rotation shaft 110, so as to further reduce the influence of radial fluctuations on the measurement accuracy of the rotation speed of the rotation shaft 110, and ensure that the distance sensor will not output error pulse signals. Thus the technical effects of optimizing the layout of the distance sensors, improving the measurement accuracy and reliability of the rotation speed of the rotation shaft 110, and reducing the failure rate of the magnetic bearing assembly 100 are realized.

In any one of the above embodiments, the distance sensors include: a third sensor 122 and a fourth sensor 124; the central angle between the third sensor 122 and the fourth sensor 124 on the first circle is 180°; the N first sensors 120 include the third sensor 122 and the fourth sensor 124.

In this embodiment, a special implementation solution is proposed. In the solution, the first sensor 120 group consists of two sensors including the third sensor 122 and the fourth sensor 124. In addition, the central angle between the third sensor 122 and the fourth sensor 124 on the first circle is 180°, that is, the third sensor 122 and the fourth sensor 124 are arranged on a same diameter. The number of the first sensors 120 and the second sensors 130 is the same. By limiting the first sensors 120 and the second sensors 130 that are including two sensors, the procurement cost of the sensor can be reduced on the basis of meeting the measurement accuracy of the rotation speed. By distributing the third sensor 122 and the fourth sensor 124 on the same diameter, on the one hand, the compensation effect between the third sensor 122 and the fourth sensor 124 can be improved, and on the other hand, the two second sensors can be distributed on the left and right sides of the diameter where the third sensor 122 and the fourth sensor 124 are disposed to further improve the distance compensation effect and improve the accuracy of determining the orientation of groove 112 on the rotation shaft 110. Thus the technical effects of optimizing the layout of the distance sensors, improving the measurement accuracy and reliability of the rotation speed of the rotation shaft 110, and reducing the failure rate of the magnetic bearing assembly 100 are realized.

In any one of the above embodiments, the distance sensors include: a fifth sensor 132 and a sixth sensor 134, the central angle between the fifth sensor 132 and the third sensor 122 on the first circle is 90°, the central angle between the fifth sensor 132 and the sixth sensor 134 is greater than or equal to 135°, and less than or equal to 225°; the N second sensors 130 include the fifth sensor 132 and the sixth sensor 134.

In the embodiment, following the above embodiment, the distribution mode of the two second sensors 130 is defined. Specifically, the second sensor 130 group consists of the fifth sensor 132 and the sixth sensor 134. On the first circle where the distance sensors are disposed, the central angles between the fifth sensor 132 and the third sensor 122 as well as the fourth sensor 124 are 90°, that is, the fifth sensor 132 is arranged on a diameter perpendicular to the diameter where the third sensor 122 and the fourth sensor 124 are disposed. On this basis, the sixth sensor 134 is arranged on an opposite side relative to the fifth sensor 132, and the central angle between the sixth sensor 134 and the fifth sensor 132 on the first circle should be greater than or equal to 135° and less than or equal to 225°. By limiting the distance between the fifth sensor 132 and the sixth sensor 134, the opposite side distance compensation effect can be ensured, which avoids the error pulse signal generated when radial fluctuations occur in the rotation shaft 110 due to distribution mode of exceeding the angle range, so as to improve the measurement accuracy of the rotation speed of the rotation shaft 110. The central angle between the fifth sensor 132 and the sixth sensor 134 can be adjusted adaptively according to the actual working condition of the rotation shaft 110. For example, when determines that the fluctuation frequency of the rotation shaft 110 in a certain direction is higher according to the working data, the central angle between the fifth sensor 132 and the sixth sensor 134 can be adjusted to make the fifth sensor 132 or the sixth sensor 134 corresponding to the high-frequency fluctuation direction, so as to further enhance the measurement accuracy of the rotation speed of the rotation shaft 110. Optionally, a sixth sensor 134 with a central angle of 180° from the fifth sensor 132 can be configured to make this distance sensor array suitable for most applications. Thus the technical effects of optimizing the layout of the distance sensors, improving the measurement accuracy and reliability of the rotation speed of the rotation shaft 110, and reducing the failure rate of the magnetic bearing assembly 100 are realized.

In any of the above embodiments, the magnetic bearing assembly 100 further includes: a locating member 140 arranged on the periphery of the rotation shaft 110; first position holes arranged on the locating member 140, and the first sensors 120 are embedded in the first position holes; and second locating holes arranged on the locating member 140, and the second sensors 130 are embedded in the second locating holes.

In the embodiment, the magnetic bearing assembly 100 further includes the locating member 140, and the locating member 140 is arranged on the periphery of the rotation shaft 110 and is spaced apart from the rotation shaft 110; the locating member 140 is used to position and mount the first sensors 120 and the second sensors 130. Specifically, the locating member 140 is provided with first locating holes and second locating holes. The first locating holes are used to position and mount the first sensors 120, and the second locating holes are used to position and mount the second sensors 130. By arranging the locating member 140, the first sensors 120 and the second sensors 130 can be accurately positioned on the predetermined mounting positions on the periphery of the rotation shaft 110 to improve the assembly accuracy and working stability. The arrangement of the locating member 140 can reduce the assembly difficulty of the first sensors 120 and the second sensors 130. The locating member 140 is a metal part, for example, the locating member 140 can be prepared by aluminum. The first sensors 120 and the second sensors 130 are embedded inside the first through holes and the second through holes respectively. By providing the metal locating member and embedding the second sensors 130 and the first sensors 120 inside the metal locating member, the electric field generated by the distance sensors and the first sensors 120 can be prevented from extending to the non-measurement direction on the basis of meeting the measurement demand through the opening of the positioning hole. Thus, the interference of the distance sensors and the first sensors 120 to the magnetic field generated by the stator can be reduced. Thus, the rotation stability of the rotor is improved and the probability of eccentric rotation is reduced. Thus the technical effects of optimizing the structure of the magnetic bearing assembly 100, improving the positioning accuracy and working stability of the sensor, improving the measurement accuracy of the rotation speed of the rotation shaft 110, and improving the working reliability of the magnetic bearing assembly 100 are realized.

In any one of the above embodiments, the locating member 140 is annular, and the locating member 140 is coaxial with the rotation shaft 110.

In the embodiment, the shape and position of the locating member 140 are defined. Specifically, the locating member 140 is an annular locating member, which can be selected as an aluminum ring. On this basis, the locating member 140 is sleeved on the periphery of the rotation shaft 110, and is spaced apart from the rotation shaft 110, and the axis of the annular locating member coincides with the axis of the rotation shaft 110. By arranging a coaxial annular locating member, the difference value between the distances between any two of the first sensors 120 and the axis of the rotation shaft 110 can be reduced, and the difference value between the distances between any two of the second sensors 130 and the axis of the rotation shaft 110 can also be reduced, so as to avoid the distance difference caused by the positioning affecting the measuring accuracy of the rotation speed and the displacement of the rotation shaft 110. Thus the technical effects of optimizing the position structure of the magnetic bearing assembly, improving the positioning accuracy and working stability of the sensor, improving the measurement reliability and accuracy of the rotation speed of the rotation shaft, and the working reliability of the magnetic bearing assembly 110 are realized.

In any one of the above embodiments, the first position holes and the second locating holes extend in the radial direction of the locating member 140.

In the embodiment, the first position holes and the second position holes on the locating member 140 extend in the radial direction of the locating member 140. Since the annular locating member 140 and the rotation shaft 110 are coaxial, the first locating holes and the second locating holes also extend in the radial direction of the rotation shaft 110, where the openings of the first locating holes and the second locating holes are towards the rotation shaft 110. The arrangement that the first position holes and the second locating holes extend in the radial direction makes the measuring ends of the first sensors 120 and the second sensors 130 to be aligned with the peripheral surface of the rotation shaft 110 in the radial direction. The positioning deviation affecting the measurement accuracy of the first sensors 120 and the second sensors 130 is avoided, and the reliability of the measured data is improved. Thus the technical effects of optimizing the position structure of the distance sensor, improving the positioning accuracy and working stability of the rotation shaft 110, and improving the working reliability of the magnetic bearing assembly 100 are realized.

In any one of the above embodiments, the magnetic bearing assembly 100 further includes an electrical control member, arranged on the locating member 140, and connected to the first sensors 120 and the second sensors 130.

In the embodiment, the magnetic bearing assembly 100 is further provided with the electrical control member. Specifically, the locating member 140 is provided with a positioning slot, and the electrical control member is inserted into the positioning slot to position and support the electrical control member through the locating member 140. One of the end surfaces of the annular locating member 140 is provided with an annular groove, the annular groove communicates the first position hole, the second positioning hole and the positioning slot, and the first sensors 120 and the second sensors 130 are then embedded in the first locating holes and the second locating holes, part of the first sensors 120 and the second sensors 130 are disposed in the annular groove. By arranging the annular groove, which can provide layout space for the connection lines between the electric control member and the sensors, avoid the connection lines from extending to the outside of the locating member 140, and prevent the connection lines from interfering with the rotation of the rotation shaft 110. On this basis, the magnetic bearing assembly 100 is further provided with an annular cover body, the cover body can be covered on the annular groove, on the one hand to prevent the electric field generated by the sensors from extending outward, on the other hand to avoid the connection lines from extending to the outside of the annular groove. Thus the technical effects of optimizing the structure of the locating member 140, improving the working safety and reliability of the magnetic bearing assembly 100, and reducing the failure rate of magnetic bearing assembly 100 are realized.

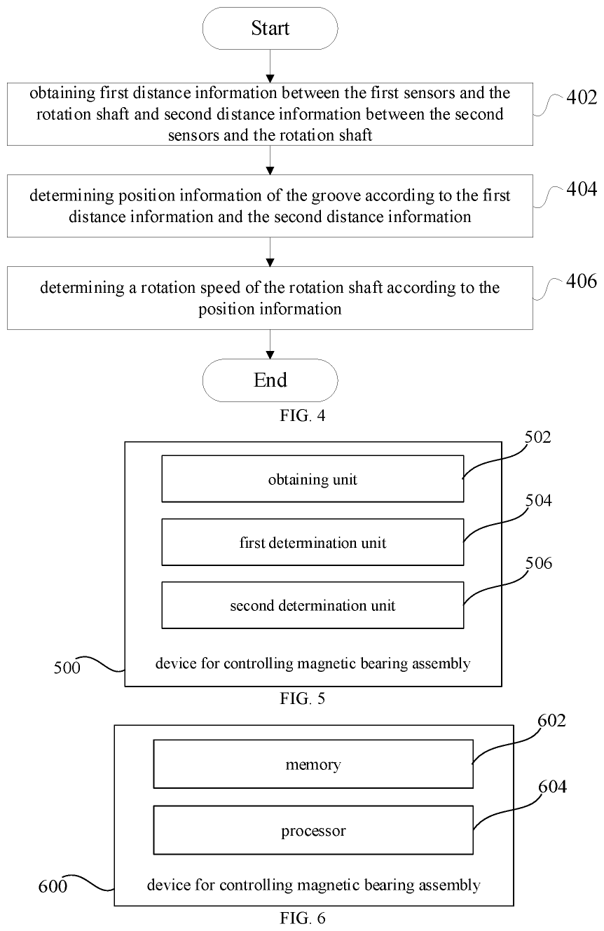

As shown in FIG. 4, at least one embodiment of the present disclosure provides a control for controlling a magnetic bearing assembly, configured for controlling the magnetic bearing assembly in any one of the above embodiments, and the method includes:

In step 402, obtaining first distance information between the first sensors and the rotation shaft and second distance information between the second sensors and the rotation shaft;

In step 404, determining position information of the groove according to the first distance information and the second distance information; and

In step 406, determining a rotation speed of the rotation shaft according to the position information.

In the embodiment, a method control for controlling the magnetic bearing assembly in any of above technical solutions. The magnetic bearing assembly includes a stator and a rotor arranged around the stator. The rotor rotates under the action of the stator to generate power. On this basis, the magnetic bearing assembly is provided with a rotation shaft, the rotation shaft can be a part of the rotor, or the rotation shaft can be a power output shaft coaxial connected with the rotor, as long as the synchronous rotation of the rotation shaft and the rotor is realized. The periphery of the rotation shaft is provided with a groove, and the magnetic bearing assembly is further provided with distance sensors, the distance sensors are arranged on the periphery of the rotation shaft, that is, in the area opposite to the peripheral surface of the rotation shaft, and the measuring end of the distance sensor is arranged opposite to the annular surface provided with the groove on the rotation shaft. The distance sensor can measure the distance between itself and the surface of the rotation shaft, after the magnetic bearing assembly is activated, the rotation shaft rotates, and the annular surface provided with the groove then rotates in front of the distance sensors. When the groove faces the probe of the distance sensor, the distance between the distance sensor and the rotation shaft is the first distance. When a position on the peripheral surface of the rotation shaft where the groove is not disposed faces the probe of the distance sensor, the distance between the distance sensor and the rotation shaft is the second distance, the groove is concave relative to the peripheral surface of the rotation shaft, and the first distance is greater than the second distance. Therefore, each time the groove passes through the measurement area of the distance sensor, the distance sensors will generate a pulse signal, that is, the rotation shaft has rotated for one revolution, and then the rotation speed of the rotation shaft can be determined according to the pulse signal.

Specifically, the distance sensors include N first sensors and N second sensors with the same number as the first sensors, and N is an integer greater than 1, that is, at least two pairs of first sensors and second sensors are provided. The first sensors and the second sensors are arranged on a first circle with an axis that is coaxial with the axis of the rotation shaft, and the distances between themselves and the rotation shaft are measured at different positions of the first circle. The N first sensors are combined as a first measurement group, and the N second sensors are combined as a second measurement group.

The specific steps to control the working of the magnetic bearing assembly are as follows: in a first step, the first distance information between the first sensors and the rotation shaft is obtained at the first sensors, and the second distance information between the second sensors and the rotation shaft is obtained at the second sensors. The distance data measured by N first sensors in the first measurement group are superimposed to obtain the first distance information, and the distance data measured by N second sensors in the second measurement group are superimposed to obtain the second distance information. In a second step, the rotation position information of the groove is determined according to the first distance information and the second distance information. Then the difference between the first distance information and the second distance information is used to determine whether the groove is transferred into the measurement area of a distance sensor. Under this measurement structure, when the rotation shaft does not have radial fluctuation, the measured data of each distance sensor are the same, so that the first distance value and the second distance value are equal. When the rotation shaft has radial fluctuation, the distance between the rotation shaft and a sensor increases, and the distance between the sensor and the rotation shaft on the opposite side will correspondingly decrease. The opposite side distance compensation phenomenon can make that the first distance value and the second distance value obtained by summing are similar to ensure that the possible error between the first distance value and the second distance value is much smaller than the depth of the groove, so as to eliminate the influence of the radial fluctuation of the rotation shaft when measures the speed. Correspondingly, when the groove is rotated into the measurement area of a distance sensor, the depth of the groove is increased in the summation distance value of the measurement group, and the summation distance value of the other measurement group cannot make up for this depth, and then the rotation position of the groove can be determined by the sudden increase in the difference between the first distance value and the second distance value. In a third step, the rotation speed of the rotation shaft can be determined according to the identified position information of the groove. The current rotation speed of the rotation shaft can be determined according to the interval time between the two distance sensors and the preset angle difference between the two distance sensors, and the rotation speed will not be affected by the radial fluctuation of the rotation shaft, and the accuracy and reliability are high, thereby improving the reliability of the measurement. Thus, the technical effects of optimizing the structure of the magnetic bearing assembly, improving the measurement accuracy of the rotation speed of the rotor, improving the control accuracy of the magnetic bearing assembly, and reducing the failure rate of the magnetic bearing assembly are realized.

As shown in FIG. 5, at least one embodiment of the present disclosure provides a device 500 for controlling a magnetic bearing assembly, and the device 500 includes: an obtaining unit 502, configured for obtaining first distance information between first sensors and a rotation shaft and second distance information between second sensors and the rotation shaft; a first determination unit 504, configured for determining position information of a groove according to the first distance information and the second distance information; and a second determination unit 506, configured for determining a rotation speed of the rotation shaft according to the position information.

In the embodiment, a device for controlling the operation of the magnetic bearing assembly in any of the technical solutions is defined. The magnetic bearing assembly includes a stator and a rotor arranged around the stator. The rotor rotates under the action of the stator to generate power. On this basis, the magnetic bearing assembly is provided with a rotation shaft, the rotation shaft can be a part of the rotor, or the rotation shaft can be a power output shaft coaxial connected with the rotor, as long as the synchronous rotation of the rotation shaft and the rotor is realized. The periphery of the rotation shaft is provided with a groove, and the magnetic bearing assembly is further provided with distance sensors, the distance sensors are arranged on the periphery of the rotation shaft, that is, in the area opposite to the peripheral surface of the rotation shaft, and the measuring end of the distance sensor is arranged opposite to the annular surface provided with the groove on the rotation shaft. The distance sensor can measure the distance between itself and the surface of the rotation shaft, after the magnetic bearing assembly is activated, the rotation shaft rotates, and the annular surface provided with the groove then rotates in front of the distance sensors. When the groove faces the probe of the distance sensor, the distance between the distance sensor and the rotation shaft is the first distance. When a position on the peripheral surface of the rotation shaft where the groove is not disposed faces the probe of the distance sensor, the distance between the distance sensor and the rotation shaft is the second distance, the groove is concave relative to the peripheral surface of the rotation shaft, and the first distance is greater than the second distance. Therefore, each time the groove passes through the measurement area of the distance sensor, the distance sensors will generate a pulse signal, that is, the rotation shaft has rotated for one revolution, and then the rotation speed of the rotation shaft can be determined according to the pulse signal.

Specifically, the distance sensors include N first sensors and N second sensors with the same number as the first sensors, and N is an integer greater than 1, that is, at least two pairs of first sensors and second sensors are provided. The first sensors and the second sensors are arranged on a first circle with an axis that is coaxial with the axis of the rotation shaft, and the distances between themselves and the rotation shaft are measured at different positions of the first circle. The N first sensors are combined as a first measurement group, and the N second sensors are combined as a second measurement group.

The device 500 for controlling the magnetic bearing assembly includes the obtaining unit 502, the first determination unit 504, and the second determination unit 506; the obtaining unit 502 can obtain the first distance information between the first sensors and the rotation shaft at the first sensors, as well as the second distance information between the second sensors and the rotation shaft at the second sensors. The distance data measured by N first sensors in the first measurement group are superimposed to obtain the first distance information, and the distance data measured by N second sensors in the second measurement group are superimposed to obtain the second distance information. The first determination unit 504 determines the rotation position information of the groove according to the first distance information and the second distance information. Then the difference between the first distance value and the second distance value is used to determine whether the groove is transferred into the measurement area of a distance sensor. Under this measurement structure, when the rotation shaft does not have radial fluctuation, the measured data of each distance sensor are the same, so that the first distance value and the second distance value are equal. When the rotation shaft has radial fluctuation, the distance between the rotation shaft and a sensor increases, and the distance between the sensor and the rotation shaft on the opposite side will correspondingly decrease. The opposite side distance compensation phenomenon can make that the first distance value and the second distance value obtained by summing are similar to ensure that the possible error between the first distance value and the second distance value is much smaller than the depth of the groove, so as to eliminate the influence of the radial fluctuation of the rotation shaft when measures the speed. Correspondingly, when the groove is rotated into the measurement area of a distance sensor, the depth of the groove is increased in the summation distance value of the measurement group, and the summation distance value of the other measurement group cannot make up for this depth, and then the rotation position of the groove can be determined by the sudden increase in the difference between the first distance value and the second distance value. The second determination unit 506 determines the rotation speed of the rotation shaft according to the identified position information of the groove. The current rotation speed of the rotation shaft can be determined according to the interval time between the two distance sensors and the preset angle difference between the two distance sensors, and the rotation speed will not be affected by the radial fluctuation of the rotation shaft, and the accuracy and reliability are high, thereby improving the reliability of the measurement. Thus, the technical effects of optimizing the structure of the magnetic bearing assembly, improving the measurement accuracy of the rotation speed of the rotor, improving the control accuracy of the magnetic bearing assembly, and reducing the failure rate of the magnetic bearing assembly are realized.

As shown in FIG. 6, at least one embodiment of the present disclosure provides a device 600 for controlling a magnetic bearing assembly, and the magnetic bearing assembly includes: a memory 602 on which a program or instruction is stored; a processor 604 configured for implementing steps of the method for controlling the magnetic bearing assembly in above embodiment when executing the programs or instructions.

In the embodiment, the device 600 for controlling the magnetic bearing assembly is proposed, which includes a memory 602 and a processor 604; the memory 602 is configured for storing instructions or programs, and the processor 604 is configured for calling and executing the instructions or programs stored in the memory 602 to implement the steps of the method for controlling the magnetic bearing component in any one of the above embodiments. Therefore, the control device has the advantages of the method for controlling the magnetic bearing component in any one of the above embodiments, and can achieve the technical effects that can be achieved by the method for controlling the magnetic bearing assembly in the above embodiments. In order to avoid repetition, which is not detailed here.

At least one embodiment of the present disclosure provides a readable storage medium on which programs or instructions are stored, and when the programs or instructions are executed by a processor to implement steps of the method for controlling the magnetic bearing assembly in the above embodiment.

In the embodiment, the readable storage medium is proposed on which instructions or programs can be called and executed by the processor. When the processor executes the instructions or programs, the steps of the method for controlling the magnetic bearing component in any one of the above embodiments can be realized. Therefore, the readable storage medium has the advantages of the method for controlling the magnetic bearing assembly in any one of the above embodiments, and can achieve the technical effects that can be achieved by the method for controlling the magnetic bearing assembly in the above embodiments. In order to avoid repetition, which is not detailed here.

A magnetic bearing assembly is provided in at least one embodiment of the present disclosure. The magnetic bearing assembly includes: the device for controlling the magnetic bearing assembly in above embodiment; and/or the readable storage medium in above embodiment.

In the embodiment, the magnetic bearing assembly including the device for controlling the magnetic bearing assembly in above embodiment and/or the readable storage medium in above technical solution is proposed. Therefore, the magnetic bearing assembly has the advantages of the device for controlling the magnetic bearing assembly and/or the readable storage medium in any one of above embodiments, and can achieve the technical effects that can be achieved by the device for controlling the magnetic bearing assembly and/or the readable storage medium in above embodiments. In order to avoid repetition, which is not detailed here.

At least one embodiment of the present disclosure provides a compressor including a magnetic bearing assembly in any of the preceding embodiments.

In the embodiment, a compressor including a magnetic bearing assembly in any one of above embodiments is proposed. Therefore, the compressor has the advantages of the magnetic bearing assembly in any one of the above embodiments, and can achieve the technical effects that can be achieved by the magnetic bearing assembly in any one above embodiments. In order to avoid repetition, which is not detailed here.

At least one embodiment of the present disclosure provides an air conditioner including a compressor in the above embodiment.

In this embodiment, an air conditioner including a compressor in the technical solution is proposed. Therefore, the air conditioner has the advantages of the compressor in the above embodiment, and can achieve the technical effect that the compressor in the above embodiment can achieve. In order to avoid repetition, which is not detailed here.

In the description of the present disclosure, the term “multiple” refers to two or more. Unless otherwise specified, the orientation or positional relationship indicated by the terms “up,” “down,” etc. is based on the orientation or positional relationship described in the accompanying drawings, and is only for the convenience of describing and simplifying the description of the present disclosure, rather than indicating or implying that the device or element referred to must have a specific orientation, be constructed and operated in a specific orientation, Therefore, it cannot be understood as a restriction on the present disclosure; The terms “connection,” “mounting,” “fixing,” etc. should be understood in a broad sense. For example, “connection” can be a fixed connection, a detachable connection, or an integrated connection; it can be directly connected or indirectly connected through intermediate media. For those skilled in the art, the specific meanings of the above terms in the present disclosure can be understood based on specific circumstances.

In the description of the present disclosure, the terms “one embodiment,” “some embodiments,” “specific embodiments,” etc., are described to mean that the specific features, structures, materials or characteristics described in conjunction with the embodiment or example are contained in at least one embodiment or example of the present disclosure. In the present disclosure, schematic representations of the above terms do not necessarily refer to identical embodiments or instances. Further, the specific features, structures, materials or characteristics described may be combined in a suitable manner in any one or more embodiments or examples.

The foregoing are only preferred embodiments of the present disclosure and are not intended to limit the present disclosure, which is subject to various changes and variations for those skilled in the art. Any modification, equivalent replacement, improvement, etc. made within the spirit and principles of the present disclosure shall be included in the scope of protection of the present disclosure.

1.-15. (canceled)

16. A magnetic bearing assembly comprising:
a rotation shaft, a peripheral surface of the rotation shaft being provided with a groove; and
a plurality of distance sensors arranged at a periphery of the rotation shaft and arranged opposite to an annular surface of the rotation shaft where the groove is arranged, the plurality of distance sensors being disposed on a circle, and the plurality of distance sensors including N first sensors and N second sensors, N being an integer greater than 1;
wherein:
the first sensors and the second sensors are arranged alternately on the circle; and
a center of the circle is disposed on an axis of the rotation shaft, and a plane where the circle is disposed is perpendicular to the axis of the rotation shaft.

17. The magnetic bearing assembly according to claim 16, wherein the distance sensors are uniformly distributed on the circle.

18. The magnetic bearing assembly according to claim 17, further comprising:
a locating member, arranged at the periphery of the rotation shaft;
a plurality of first locating holes arranged on the locating member, the first sensors being embedded in the first locating holes, respectively; and
a plurality of second locating holes arranged on the locating member, the second sensors being embedded in the second locating holes, respectively.

19. The magnetic bearing assembly according to claim 16, wherein, on the circle, a central angle between a first one of the N first sensors and a second one of the N first sensors is 180°.

20. The magnetic bearing assembly according to claim 19, wherein, on the circle:
a central angle between the first one of the N first sensor and a first one of the N second sensors is 90°, and
a central angle between the first one of the N second sensors and a second one of the N second sensors is greater than or equal to 135° and less than or equal to 225°.

21. The magnetic bearing assembly according to claim 20, further comprising:
a locating member, arranged at the periphery of the rotation shaft;
a plurality of first locating holes arranged on the locating member, the first sensors being embedded in the first locating holes, respectively; and
a plurality of second locating holes arranged on the locating member, the second sensors being embedded in the second locating holes, respectively.

22. The magnetic bearing assembly according to claim 19, further comprising:
a locating member, arranged at the periphery of the rotation shaft;
a plurality of first locating holes arranged on the locating member, the first sensors being embedded in the first locating holes, respectively; and
a plurality of second locating holes arranged on the locating member, the second sensors being embedded in the second locating holes, respectively.

23. The magnetic bearing assembly according to claim 16, further comprising:
a locating member, arranged at the periphery of the rotation shaft;
a plurality of first locating holes arranged on the locating member, the first sensors being embedded in the first locating holes, respectively; and
a plurality of second locating holes arranged on the locating member, the second sensors being embedded in the second locating holes, respectively.

24. The magnetic bearing assembly according to claim 23, wherein the locating member is annular, and the locating member is coaxial with the rotation shaft.

25. The magnetic bearing assembly according to claim 24, wherein the first locating holes and the second locating holes extend in a radial direction of the locating member.

26. The magnetic bearing assembly according to claim 23, further comprising:
an electric control member arranged on the locating member and connected with the first sensors and the second sensors.

27. A method for controlling the magnetic bearing assembly according to claim 16, comprising:
obtaining first distance information between the first sensors and the rotation shaft and second distance information between the second sensors and the rotation shaft;
determining position information of the groove according to the first distance information and the second distance information; and
determining a rotation speed of the rotation shaft according to the position information.

28. A non-transitory computer-readable storage medium storing one or more programs or instructions that, when executed by at least one processor, cause the at least one processor to perform the method according to claim 27.

29. A device for controlling the magnetic bearing assembly according to claim 16, comprising:
at least one memory storing one or more programs or instructions; and
at least one processor configured execute the one or more programs or instructions to:
obtain first distance information between the first sensors and the rotation shaft and second distance information between the second sensors and the rotation shaft;
determine position information of the groove according to the first distance information and the second distance information; and
determine a rotation speed of the rotation shaft according to the position information.

30. A compressor comprising:
the magnetic bearing assembly according to claim 16.

31. An air conditioner comprising:
the compressor according to claim 30.

32. A magnetic bearing assembly comprising:
a rotation shaft, a peripheral surface of the rotation shaft being provided with a groove;
a plurality of distance sensors arranged at a periphery of the rotation shaft and arranged opposite to an annular surface of the rotation shaft where the groove is arranged, the plurality of distance sensors being disposed on a circle, and the plurality of distance sensors including N first sensors and N second sensors, N being an integer greater than 1, wherein:
the first sensors and the second sensors are arranged alternately on the circle; and
a center of the circle is disposed on an axis of the rotation shaft, and a plane where the circle is disposed is perpendicular to the axis of the rotation shaft; and
a control device including:
at least one memory storing one or more programs or instructions; and
at least one processor configured execute the one or more programs or instructions to:
obtain first distance information between the first sensors and the rotation shaft and second distance information between the second sensors and the rotation shaft;
determine position information of the groove according to the first distance information and the second distance information; and
determine a rotation speed of the rotation shaft according to the position information.

33. A compressor comprising:
the magnetic bearing assembly according to claim 32.

34. An air conditioner comprising:
the compressor according to claim 33.

35. A magnetic bearing assembly comprising:
a rotation shaft, a peripheral surface of the rotation shaft being provided with a groove;
a plurality of distance sensors arranged at a periphery of the rotation shaft and arranged opposite to an annular surface of the rotation shaft where the groove is arranged, the plurality of distance sensors being disposed on a circle, and the plurality of distance sensors including N first sensors and N second sensors, N being an integer greater than 1, wherein:
the first sensors and the second sensors are arranged alternately on the circle; and
a center of the circle is disposed on an axis of the rotation shaft, and a plane where the circle is disposed is perpendicular to the axis of the rotation shaft; and
a non-transitory computer-readable storage medium storing one or more programs or instructions that, when executed by at least one processor, cause the at least one processor to:
obtain first distance information between the first sensors and the rotation shaft and second distance information between the second sensors and the rotation shaft;
determine position information of the groove according to the first distance information and the second distance information; and
determine a rotation speed of the rotation shaft according to the position information.
